(19) United States
(12) Patent Application Publication
(10) Pub. No.: US 2024/0279499 A1
(43) Pub. Date: Aug. 22, 2024

(54) Dispersant-Containing Liquid And Aqueous Coloring Material Dispersion Liquid

(71) Applicant: SEIKO EPSON CORPORATION, Tokyo (JP)

(72) Inventors: Tomoya IWASAKI, Shiojiri (JP); Kenji KITADA, Shiojiri (JP); Koichi TERAO, Suwa (JP); Hajime KAKISHITA, Shiojiri (JP); Hiroshi ITO, Matsumoto (JP)

(21) Appl. No.: 18/441,099

(22) Filed: Feb. 14, 2024

(30) Foreign Application Priority Data
Feb. 15, 2023 (JP) 2023-021991

(51) Int. Cl. C09D 11/328; C09D 11/033; C09D 11/104

(52) U.S. Cl. CPC C09D 11/328; C09D 11/033; C09D 11/104

(57) ABSTRACT

A dispersant-containing liquid of the present disclosure contains anionic water-soluble polyester containing a carboxylate and/or a sulfonate, polyalkylene glycols, and water. When a content of the water-soluble polyester in the dispersant-containing liquid is defined as XPEs [mass %] and a content of the polyalkylene glycols in the dispersant-containing liquid is defined as XPAG [mass %], it is preferable that Expression (4) be satisfied.

$$0.01 \leq XPAG / XPEs \leq 2. \qquad ( 4 )$$

The present application is based on, and claims priority from JP Application Serial Number 2023-021991, filed Feb. 15, 2023, the disclosure of which is hereby incorporated by reference herein in its entirety.

### BACKGROUND

### 1. Technical Field

The present disclosure relates to a dispersant-containing liquid and an aqueous coloring material dispersion liquid.

### 2. Related Art

A dispersion liquid in which a dispersoid is dispersed in a dispersion medium containing water has been used for various applications.

Examples of such a dispersion liquid include an ink in which a coloring material is dispersed in a dispersion medium containing water.

A dispersant is added to such a dispersion liquid in some cases for the purpose of improving dispersibility of the dispersoid.

A resin type dispersant is particularly advantageous as the dispersant from the viewpoint of having a high affinity for a coloring material, less odor, and the like.

As an ink formed of such a resin type dispersant, for example, a disperse dye ink for ink jet recording which contains water, a water-soluble organic solvent, a disperse dye, and water-soluble polyester having an acid value of 100 to 250 is known (see JP-A-10-114865).

However, in the related art, since the resin type dispersant has low initial wettability with respect to a coloring material, disintegration and dispersion powder of the coloring material for dispersion of the coloring material during preparation of an ink which is a dispersion liquid are insufficient, the dispersion time increases, and thus the stress on the organic coloring material during dispersion increases. Therefore, problems of insufficient dispersion stability of the ink and the like are likely to occur.

### SUMMARY

The present disclosure has been made to solve the above-described problems, and can be realized by the following aspects.

According to an aspect of the present disclosure, there is provided a dispersant-containing liquid including anionic water-soluble polyester containing a carboxylate and/or a sulfonate, polyalkylene glycols, and water.

According to another aspect of the present disclosure, there is provided an aqueous coloring material dispersion liquid including anionic water-soluble polyester containing a carboxylate and/or a sulfonate, polyalkylene glycols, water, and at least one organic coloring material selected from the group consisting of a pigment, a disperse dye, and an oil-soluble dye.

### BRIEF DESCRIPTION OF THE DRAWINGS

FIG. 1 is a table collectively listing conditions of water-soluble polyesters obtained in Synthesis Examples 1 to 9.

FIG. 2 is a table collectively listing conditions of water-soluble polyesters obtained in Synthesis Examples 10 to 17.

FIG. 3 is a table collectively listing conditions of dispersant-containing liquids according to Examples A1 to A11.

FIG. 4 is a table collectively listing conditions of dispersant-containing liquids according to Examples A12 to A22.

FIG. 5 is a table collectively listing conditions of dispersant-containing liquids according to Examples A23 to A31 and Comparative Examples A1 and A2.

FIG. 6 is a table collectively listing conditions of stock solutions of ink jet inks according to Examples B1 to B12.

FIG. 7 is a table collectively listing conditions of stock solutions of ink jet inks according to Examples B13 to B24.

FIG. 8 is a table collectively listing conditions of stock solutions of ink jet inks according to Examples B25 to B33 and Comparative Examples B1 and B2.

FIG. 9 is a table collectively listing conditions of ink jet inks according to Examples C1 to C12.

FIG. 10 is a table collectively listing conditions of ink jet inks according to Examples C13 to C24.

FIG. 11 is a table collectively listing conditions of ink jet inks according to Examples C25 to C33 and Comparative Examples C1 and C2.

FIG. 12 is a table collectively listing evaluation results of stock solutions of ink jet inks according to Examples B1 to B18.

FIG. 13 is a table collectively listing evaluation results of stock solutions of ink jet inks according to Examples B19 to B33 and Comparative Examples B1 and B2.

FIG. 14 is a table collectively listing evaluation results of ink jet inks according to Examples C1 to C18.

FIG. 15 is a table collectively listing evaluation results of ink jet inks according to Examples C19 to C33 and Comparative Examples C1 and C2.

### DESCRIPTION OF EMBODIMENTS

Hereinafter, preferred embodiments of the present disclosure will be described in detail.

### <1> Dispersant-Containing Liquid

First, a dispersant-containing liquid of the present disclosure will be described.

The dispersant-containing liquid of the present disclosure is a dispersant-containing liquid containing anionic water-soluble polyester containing a carboxylate and/or a sulfonate, polyalkylene glycols, and water.

In this manner, it is possible to provide a dispersant-containing liquid that can be used for disintegration and dispersion suitable for an organic coloring material by performing a dispersion treatment for a short time, can reduce the stress on the organic coloring material during the dispersion, and can be used for preparation of an aqueous coloring material dispersion liquid with excellent dispersion stability of the organic coloring material and excellent storage stability. More specific details are as follows. That is, the wettability of the dispersant-containing liquid with respect to the organic coloring material can be improved, and disintegration and crushing of the organic coloring material are easily carried out so that the time required for preparation of the aqueous coloring material dispersion liquid can be reduced. Since disintegration and crushing of the organic coloring material are easily carried out, the stress on the organic coloring material during the dispersion can be reduced, and thus the dispersion stability of the organic coloring material in the aqueous coloring material dispersion liquid and the storage stability of the aqueous coloring material dispersion liquid can be improved.

Further, drying resistance of the aqueous coloring material dispersion liquid prepared by using the dispersant-containing liquid can be improved. Further, indicators of the drying resistance include the difficulty of drying the dispersant-containing liquid and the redispersibility and the resolubility of the solid content precipitated when the dispersant-containing liquid is dried. Further, since the affinity and the adsorptivity for the organic coloring material do not compete with each other between the moisturizer and the surface tension adjuster to be added, the dispersion stability of the organic coloring material is not adversely affected, which is suitable for preparation of the aqueous coloring material dispersion liquid.

On the contrary, satisfactory results cannot be obtained when the above-described conditions are not satisfied.

For example, when the polyester has a structure that does not contain both of the carboxylate and the sulfonate, the water solubility of the polyester cannot be sufficiently improved, and accordingly, the dispersion stability of the organic coloring material and the storage stability of the aqueous coloring material dispersion liquid in a case of preparing the aqueous coloring material dispersion liquid containing an organic coloring material by using the dispersant-containing liquid cannot be sufficiently improved. Further, the drying resistance of the aqueous coloring material dispersion liquid is also degraded.

Further, when the dispersant-containing dispersion liquid does not contain polyalkylene glycols, the time required for the dispersion treatment performed on the organic coloring material increases, and thus the productivity of the aqueous coloring material dispersion liquid is significantly decreased. Further, the stress on the organic coloring material during the dispersion is increased even when the aqueous coloring material dispersion liquid in which the organic coloring material is dispersed is obtained, and as a result, the dispersion stability of the organic coloring material in the aqueous coloring material dispersion liquid and the storage stability of the aqueous coloring material dispersion liquid are degraded.

### <1-1> Water

The dispersant-containing liquid of the present disclosure contains water. The water mainly has a function of imparting the fluidity to the dispersant-containing liquid and the aqueous coloring material dispersion liquid prepared by using the dispersant-containing liquid and thus functions as a dispersion medium or a solvent.

It is preferable that ion exchange water, pure water, or ultrapure water be used as water.

The lower limit of the content of water in the dispersant-containing liquid is not particularly limited, but is preferably 30.0% by mass, more preferably 35.0% by mass, and still more preferably 40.0% by mass. Further, the upper limit of the content of water in the dispersant-containing liquid is not particularly limited, but is preferably 93.0% by mass, more preferably 90.0% by mass, and still more preferably 87.0% by mass.

In this manner, the viscosity of the dispersant-containing liquid can be more reliably adjusted to a suitable value. Further, the dispersion stability of the organic coloring material in the aqueous coloring material dispersion liquid prepared by using the dispersant-containing liquid can be further improved.

### <1-2> Water-Soluble Polyester Serving as Dispersant

The polyester is a general term of a polymer material having an ester bond in the main chain and typically has a chemical structure in which a polyol component containing a plurality of hydroxyl groups in a molecule and a polycarboxylic acid component containing a plurality of carboxyl groups in a molecule are dehydrated and condensed.

Particularly, the dispersant-containing liquid of the present disclosure contains water-soluble polyester containing a carboxylate and/or a sulfonate as a dispersant.

The water-soluble polyester may contain at least one of a carboxylate or a sulfonate, but it is preferable that the water-soluble polyester contain both a carboxylate and a sulfonate.

In this manner, the water solubility of the water-soluble polyester can be further enhanced. Further, the dispersion stability of the organic coloring material when the aqueous coloring material dispersion liquid in which the organic coloring material is dispersed is prepared by using the dispersant-containing liquid can be further improved. Further, the drying resistance of the aqueous coloring material dispersion liquid is also further improved. Further, when the aqueous coloring material dispersion liquid is an ink jet composition, the color developability of a recorded portion formed by using the ink jet composition can be further improved while the jetting stability of the ink jet composition using an ink jet method is further improved. Further, the water resistance of a recorded portion formed by using the ink jet composition can be further improved.

When the water-soluble polyester contains both a carboxylate and a sulfonate, the carboxylate and the sulfonate may be present at any site of a molecule of the water-soluble polyester or may be present in the same monomer constituting the water-soluble polyester, but it is preferable that the carboxylate and the sulfonate be present in different monomers constituting the water-soluble polyester. That is, it is preferable that the water-soluble polyester contain a first monomer having a carboxylate and a second monomer having a sulfonate as constituent monomers.

In this manner, the water solubility of the water-soluble polyester can be further enhanced. Further, the dispersion stability of the organic coloring material when the aqueous coloring material dispersion liquid in which the organic coloring material is dispersed is prepared by using the dispersant-containing liquid can be further improved. Further, the drying resistance of the aqueous coloring material dispersion liquid is also further improved. Further, when the aqueous coloring material dispersion liquid is an ink jet composition, the color developability of a recorded portion formed by using the ink jet composition can be further improved while the jetting stability of the ink jet composition using an ink jet method is further improved. Further, the water resistance of a recorded portion formed by using the ink jet composition can be further improved.

Examples of the first monomer having a carboxylate include a salt of a tri- or higher valent carboxylic acid compound and a salt of a carboxyl group-containing polyol, and the first monomer can be used alone or in combination of two or more kinds selected from these. Examples of the tri- or higher valent carboxylic acid compound include tricarballylic acid, p-alanine diacetic acid, trimellitic acid, trimesic acid, pyromellitic acid, and mellophanic acid. Examples of the carboxyl group-containing polyol include N,N-bis(2-hydroxyethyl)-β-alanine and N,N-bis(2-hydroxyethyl)succinamic acid. Further, when a resin terminal modifier described below is used as the first monomer, for example, a salt of a divalent polycarboxylic acid monomer described below can be used as the resin terminal modifier.

Examples of the second monomer having a sulfonate include a salt of a sulfonated polycarboxylic acid monomer and a salt of a sulfonated polyol monomer, and the second monomer can be used alone or in combination of two or more kinds selected from these. Examples of the sulfonated polycarboxylic acid monomer include sulfoisophthalic acid, sulfoterephthalic acid, sulfophthalic acid, sulfosuccinic acid, sulfomalonic acid, 2,3-disulfosuccinic acid, sulfotartaric acid, sulfomalic acid, sulfomaleic acid, sulfofumaric acid, 1-sulfo-1,2-cyclohexanedicarboxylic acid, and 3-(sodiooxysulfonyl)glutaric acid. Examples of the sulfonated polyol monomer include 2,3-dihydroxy-1-propanesulfonic acid, 3-[bis(2-hydroxyethyl)amino]-1-propanesulfonic acid, and 2-hydroxy-3-[bis(2-hydroxyethyl)amino]-1-propanesulfonic acid.

The lower limit of the proportion of the sum of the content of the first monomer and the content of the second monomer in all monomers constituting the water-soluble polyester is preferably 1.0 mol %, more preferably 1.5 mol %, and still more preferably 2.0 mol %. Further, the upper limit of the proportion of the sum of the content of the first monomer and the content of the second monomer in all monomers constituting the water-soluble polyester is preferably 25.0 mol %, more preferably 22.0 mol %, and still more preferably 20.0 mol %.

In this manner, the water solubility of the water-soluble polyester can be further enhanced. Further, the dispersion stability of the organic coloring material when the aqueous coloring material dispersion liquid in which the organic coloring material is dispersed is prepared by using the dispersant-containing liquid can be further improved. Further, the drying resistance of the aqueous coloring material dispersion liquid is also further improved. Further, when the aqueous coloring material dispersion liquid is an ink jet composition, the color developability of a recorded portion formed by using the ink jet composition can be further improved while the jetting stability of the ink jet composition using an ink jet method is further improved. Further, the water resistance of a recorded portion formed by using the ink jet composition can be further improved.

When the molar ratio of the amount of the carboxylate to the amount of the sulfonate in the water-soluble polyester, that is, a ratio Xc/Xs in a case where the amount of the sulfonate in the water-soluble polyester is defined as Xs [mol] and the amount of the carboxylate in the water-soluble polyester is defined as Xc [mol] is defined as R_{c/s}, it is preferable to satisfy a relationship of 0≤R_{c/s}≤200, more preferable to satisfy a relationship of 50≤R_{c/s}≤150, and still more preferable to satisfy a relationship of 60≤R_{c/s}≤120.

In this manner, the water solubility of the water-soluble polyester can be further enhanced. Further, the dispersion stability of the organic coloring material when the aqueous coloring material dispersion liquid in which the organic coloring material is dispersed is prepared by using the dispersant-containing liquid can be further improved. Further, the drying resistance of the aqueous coloring material dispersion liquid is also further improved. Further, when the aqueous coloring material dispersion liquid is an ink jet composition, the color developability of a recorded portion formed by using the ink jet composition can be further improved while the jetting stability of the ink jet composition using an ink jet method is further improved. Further, the water resistance of a recorded portion formed by using the ink jet composition can be further improved.

The carboxylate and the sulfonate may be present, for example, at a side chain of a molecule of the water-soluble polyester or at the terminal of the main chain of the water-soluble polyester.

When the carboxylate is present at a side chain of a molecule of the water-soluble polyester, the carboxylate can be suitably introduced, for example, by using tri- or higher valent polycarboxylic acid or lower alkyl ester thereof, or an acid anhydride as a polycarboxylic acid monomer or by using a compound containing two or more hydroxyl groups and one or more carboxyl groups as a polyol monomer in the synthesis of the water-soluble polyester.

Further, when the carboxylate is present at the terminal of the main chain of the water-soluble polyester, the carboxylate can be suitably introduced, for example, by adjusting reaction conditions so that a hydroxyl group is present at the terminal to synthesize a polymer and reacting the hydroxyl group at the terminal of the polymer with a carboxylate of a di- or higher valent polycarboxylic acid monomer serving as a resin terminal modifier, as described in specific examples below. Further, in this case, lower alkyl ester of the di- or higher valent polycarboxylic acid monomer or an acid anhydride can also be used as the resin terminal modifier.

When the sulfonate is present at a side chain of a molecule of the water-soluble polyester, the sulfonate can be suitably introduced, for example, by using di- or higher valent polycarboxylic acid containing a sulfo group or lower alkyl ester thereof or an acid anhydride as a polycarboxylic acid monomer or by using a compound containing a sulfo group and two or more hydroxyl groups as a polyol monomer in the synthesis of the water-soluble polyester.

Further, when the sulfonate is present at the terminal of the main chain of the water-soluble polyester, the sulfonate can be suitably introduced, for example, by adjusting reaction conditions so that a hydroxyl group is present at the terminal to synthesize a polymer and reacting the hydroxyl group at the terminal of the polymer with a carboxyl group of a resin terminal modifier containing a carboxyl group and a sulfo group.

Examples of the polycarboxylic acid monomer include aromatic polycarboxylic acids such as phthalic acid, terephthalic acid, isophthalic acid, 2,5-norbornanedicarboxylic acid, 1,4-naphthalenedicarboxylic acid, biphenyldicarboxylic acid, 4,4′-sulfonyldibenzoic acid, and 2,5-naphthalenedicarboxylic acid, aliphatic polycarboxylic acids such as oxalic acid, malonic acid, glutaric acid, adipic acid, pimelic acid, azelaic acid, sebacic acid, fumaric acid, maleic acid, itaconic acid, 1,3-cyclopentanedicarboxylic acid, 1,2-cyclohexanedicarboxylic acid, 1,3-cyclohexanedicarboxylic acid, and 1,4-cyclohexanedicarboxylic acid, lower alkyl ester thereof, and an anhydride, and the polycarboxylic acid monomer can be used alone or in combination of two or more kinds selected from these.

Examples of the polyol monomer include aliphatic polyols such as ethylene glycol, diethylene glycol, triethylene glycol, polyethylene glycol, propylene glycol, dipropylene glycol, tripropylene glycol, polypropylene glycol, 1,3-propanediol, neopentyl glycol, 1,3-butanediol, 1,4-butanediol, 1,5-pentanediol, 1,6-hexanediol, 2,2,4-trimethyl-1,6-hexanediol, 1,2-cyclohexanedimethanol, 1,3-cyclohexanedimethanol, 1,4-cyclohexanedimethanol, and 2,2′-bis(4-hydroxycyclohexyl)isopropane, and aromatic polyols such as 1,4-benzenedimethanol, 1,3-benzenedimethanol, 1,2-benzenedimethanol, biphenol, 4,4′-methylenebisphenol, 2,2-di(p-hydroxyphenyl)propane, styrene glycol, 2-phenyl-1,3-propanediol, and naphthalenediol, and the polyol monomer can be used alone or in combination of two or more kinds selected from these.

It is preferable that the water-soluble polyester contain a monomer having an aromatic ring structure as a constituent monomer.

In this manner, when the aqueous coloring material dispersion liquid of the present disclosure is prepared by using the dispersant-containing liquid of the present disclosure and the organic coloring material, the organic coloring material can be more suitably adsorbed on the water-soluble polyester, and the dispersion stability of the organic coloring material in the aqueous coloring material dispersion liquid can be further improved.

When the water-soluble polyester contains a monomer having an aromatic ring structure as a constituent monomer, the lower limit of the proportion of the monomer having an aromatic ring structure in all constituent monomers of the water-soluble polyester is preferably 25 mol %, more preferably 30 mol %, and still more preferably 33 mol %. Further, the upper limit of the proportion of the monomer having an aromatic ring structure in all constituent monomers of the water-soluble polyester is preferably 75 mol %, more preferably 70 mol %, and still more preferably 65 mol %.

In this manner, when the aqueous coloring material dispersion liquid is prepared by using the dispersant-containing liquid of the present disclosure and the organic coloring material, the hydrophobic adsorption power of the water-soluble polyester with respect to the organic coloring material can be sufficiently increased, the flexibility of the molecules of the water-soluble polyester can be further improved, and the molecules of the water-soluble polyester can more suitably follow the surface shape of the organic coloring material. As a result, the organic coloring material can be more suitably adsorbed on the water-soluble polyester, and the dispersion stability of the organic coloring material in the aqueous coloring material dispersion liquid can be further improved.

When the water-soluble polyester contains a monomer having an aromatic ring structure as a constituent monomer, it is preferable that the monomer having an aromatic ring structure do not contain a water-soluble group.

In this manner, when the aqueous coloring material dispersion liquid of the present disclosure is prepared by using the dispersant-containing liquid of the present disclosure and the organic coloring material, the organic coloring material can be more suitably adsorbed on the water-soluble polyester, and the dispersion stability of the organic coloring material in the aqueous coloring material dispersion liquid can be further improved.

Examples of the water-soluble group include a sulfo group, a carboxyl group, a phosphoric acid group, and salts thereof.

Examples of an aromatic ring in a water-insoluble aromatic monomer include a phenyl group, a biphenyl group, a naphthyl group, and a functional group in which some of the hydrogen atoms contained in any of these functional groups have been substituted with other atoms or atomic groups, and the aromatic ring can be used alone or in combination of two or more kinds selected from these.

The lower limit of the number average molecular weight of the water-soluble polyester is preferably 1,500, more preferably 1,800, and still more preferably 2,000. The upper limit of the number average molecular weight of the water-soluble polyester is preferably 15,000, more preferably 12,000, and still more preferably 10,000.

With such a configuration, the water solubility of the water-soluble polyester serving as a dispersant can be further improved, and the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

The lower limit of the acid value of the water-soluble polyester is preferably 7 mgKOH/g, more preferably 10 mgKOH/g, and still more preferably 15 mgKOH/g. Further the upper limit of the acid value of the water-soluble polyester is preferably 500 mgKOH/g, more preferably 400 mgKOH/g, and still more preferably 250 mg KOH/g.

In this manner, the electrostatic repulsive force between resins is improved, resin molecules can be present at appropriate distances, and thus an effect of increasing the dispersibility can be obtained.

It is preferable that the water-soluble polyester be soluble in water at least in a pH range of 7 or greater and 10 or less.

In this manner, an effect of suppressing structural deterioration of the resin components with time can be obtained.

Here, the term “water-soluble” denotes that the solubility of a substance in water at 20° C. is 1.0 g/100 g water or greater, and the solubility of a substance in water at 20° C. is preferably 5.0 g/100 g water or greater and more preferably 10.0 g/100 g or greater.

The lower limit of the content of the water-soluble polyester in the dispersant-containing liquid is preferably 3.0% by mass, more preferably 4.0% by mass, and still more preferably 4.5% by mass. Further, the upper limit of the content of the water-soluble polyester in the dispersant-containing liquid is preferably 35.0% by mass, more preferably 30.0% by mass, and still more preferably 28.0% by mass.

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

### <1-3> Polyalkylene Glycols

The dispersant-containing liquid of the present disclosure contains polyalkylene glycols.

In a case where the dispersant-containing liquid contains polyalkylene glycols along with the above-described water-soluble polyester, an increase in viscosity of the aqueous coloring material dispersion liquid and generation of foreign matter in the aqueous coloring material dispersion liquid when the aqueous coloring material dispersion liquid is prepared by using the dispersant-containing liquid can be suppressed. Further, the time required for disintegration and dispersion of the coloring material can be reduced as compared with when the coloring material is disintegrated and dispersed by using only an anionic resin as a dispersant, and thus overdispersion can be suppressed. A decrease in dispersion stability due to the overdispersion can be avoided by suppressing the overdispersion.

Examples of the polyalkylene glycols include polyalkylene glycol and polyalkylene glycol derivatives such as an etherified product in which at least one hydroxyl group of polyalkylene glycol is etherified, and an esterified product in which at least one hydroxyl group of polyalkylene glycol is esterified, and the polyalkylene glycols can be used alone or in combination of two or more kinds selected from these.

Examples of the polyalkylene glycol include a homopolymer or a copolymer of alkylene glycol such as ethylene glycol, propylene glycol, or butylene glycol. Examples of the homopolymer of alkylene glycol include polyethylene glycol, polypropylene glycol, and polybutylene glycol. The copolymer of alkylene glycol may be a random copolymer or a block copolymer.

Examples of the etherified product of polyalkylene glycol include a compound having a structure in which at least some of the hydroxyl groups in the polyalkylene glycol have been substituted with a methylether group, an ethylether group, or a propylether group.

Further, examples of the esterified product of polyalkylene glycol include a compound having a structure in which at least some of the hydroxyl groups in the polyalkylene glycol have been substituted with an acetoxy group, a propionyloxy group, or a butyryloxy group.

Particularly, as the polyalkylene glycols, polyalkylene glycol is preferable, a copolymer of alkylene glycol is more preferable, and a block copolymer is still more preferable.

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

Further, it is preferable that the polyalkylene glycols be nonionic.

In this manner, when the aqueous coloring material dispersion liquid containing an organic coloring material is prepared by using the dispersant-containing liquid, aggregation of the organic coloring material can be more effectively prevented, and the storage stability of the aqueous coloring material dispersion liquid can be further improved. Further, when the aqueous coloring material dispersion liquid is an ink jet ink, the jetting stability of the ink jet ink can be further improved.

Particularly, a compound represented by Formula (1) is preferable as the polyalkylene glycols.

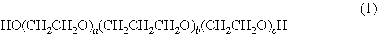

(In Formula (1), a, b, and c each independently represent an integer of 1 or greater.)

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

When the dispersant-containing liquid contains a compound represented by Formula (1) as the polyalkylene glycols, the lower limit of the number average molecular weight of a polyoxypropylene chain constituting the polyalkylene glycols is preferably 1,500, more preferably 2,000, and still more preferably 3,000. Further, when the dispersant-containing liquid contains a compound represented by Formula (1) as the polyalkylene glycols, the upper limit of the number average molecular weight of a polyoxypropylene chain constituting the polyalkylene glycols is preferably 5,000 and more preferably 4,500.

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

When the dispersant-containing liquid contains a compound represented by Formula (1) as the polyalkylene glycols, the lower limit of the proportion of a polyoxyethylene chain in the polyalkylene glycols is preferably 20% by mass, more preferably 40% by mass, and still more preferably 75% by mass.

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

The lower limit of the number average molecular weight of the polyalkylene glycols is preferably 3,000, more preferably 7,000, still more preferably 9,000, and most preferably 10,000. The upper limit of the number average molecular weight of the polyalkylene glycols is preferably 30,000, more preferably 28,000, and most preferably 25,000.

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

The clouding point of the polyalkylene glycols is preferably 67° C. or higher, more preferably 75° C. or higher, and still more preferably 100° C. or higher.

In this manner, an effect of suppressing aggregation of foreign matter generated in the process of dispersion, the resin, and the coloring material can be obtained.

The lower limit of the content of the polyalkylene glycols in the dispersant-containing liquid is preferably 0.1% by mass, more preferably 0.3% by mass, and still more preferably 0.5% by mass. Further, the upper limit of the content of the polyalkylene glycols in the dispersant-containing liquid is preferably 20.0% by mass, more preferably 10.0% by mass, and still more preferably 3.0% by mass.

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

When the content of the water-soluble polyester in the dispersant-containing liquid is defined as XPEs [mass %] and the content of the polyalkylene glycols in the dispersant-containing liquid is defined as XPAG [mass %], it is preferable to satisfy a relationship of 0.01≤XPAG/XPEs≤2.00, more preferable to satisfy a relationship of 0.03≤XPAG/XPEs≤1.00, and still more preferable to satisfy a relationship of 0.05≤XPAG/XPEs≤0.50.

In this manner, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, the viscosity of the dispersant-containing liquid or the aqueous coloring material dispersion liquid prepared by using the dispersant-containing liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved. Further, disintegration and dispersion of the organic coloring material can be suitably carried out by performing a dispersion treatment for a shorter time, and thus the productivity of the aqueous coloring material dispersion liquid is further improved.

### <1-4> Basic Substance

The dispersant-containing liquid of the present disclosure may contain a basic substance as a pH adjuster.

In this manner, the pH of the dispersant-containing liquid can be adjusted to be in a suitable range of weak basicity, a more suitable dissolved state of the water-soluble polyester in the dispersant-containing liquid can be ensured, and thus, for example, problems of aggregation, sedimentation, and the like due to insolubilization of the water-soluble polyester can be more effectively prevented. As a result, for example, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, when the aqueous coloring material dispersion liquid is an ink jet composition, the jetting stability of the ink jet composition using an ink jet method can be further improved.

Examples of the basic substance include a monovalent inorganic base, a divalent inorganic base, and a water-soluble organic amine, and the basic substance can be used alone or in combination of two or more kinds selected from these.

Examples of the monovalent inorganic base include a hydroxide of an alkali metal such as lithium hydroxide, sodium hydroxide, or potassium hydroxide, and ammonia. Among these, particularly, a hydroxide of an alkali metal is preferable, and sodium hydroxide is more preferable.

Examples of the divalent inorganic base include a hydroxide of an alkaline earth metal.

For example, an organic amine whose solubility in water at 20° C. is 10 g/100 g water or greater can be used as the water-soluble organic amine. Specific examples of the water-soluble organic amine include alkylamines such as monoethylamine, diethylamine, triethylamine, monomethylamine, dimethylamine, and trimethylamine, diethanolamine, triethanolamine, diisopropanolamine, triisopropanolamine, butyldiethanolamine, ethyldiethanolamine, and 2-amino-2-ethyl-1,3-propanediol.

Particularly, hydroxyamine is preferable, diolamine or triolamine is more preferable, and triethanolamine is still more preferable as the water-soluble amine.

In this manner, since the boiling point of the water-soluble organic amine can be increased and high hygroscopicity can also be obtained while the water solubility of the water-soluble organic amine is particularly increased, precipitation of the solid content due to unintentional drying of the dispersant-containing liquid or the aqueous coloring material dispersion liquid prepared by using the dispersant-containing liquid can be effectively prevented.

Further, in the synthesis of the water-soluble polyester, the basic substance may be, for example, used such that the monomer is in the form of a salt or mixed with the synthesized water-soluble polyester.

### <1-5> Other Components

The dispersant-containing liquid of the present disclosure may contain components other than the above-described components. Hereinafter, such components will be referred to as “other components” in this section.

Examples of other components include dispersants and resin components other than the water-soluble polyester, solvents other than water, moisturizers, surface tension adjusters, preservatives, and chelating agents, and the other components can be used alone or in combination of two or more kinds selected from these.

Here, the dispersant-containing liquid of the present disclosure does not contain at least one organic coloring material selected from the group consisting of a pigment, a disperse dye, and an oil-based dye. The aqueous coloring material dispersion liquid of the present disclosure described below contains an organic coloring material in addition to the constituent components of the dispersant-containing liquid of the present disclosure described above.

Further, the content of the other components in the dispersant-containing liquid of the present disclosure is preferably 10.0% by mass or less, more preferably 5.0% by mass or less, and still more preferably 3.0% by mass or less.

### <1-6> Other Conditions

It is preferable that the dispersant-containing liquid of the present disclosure satisfy the conditions described below.

For example, the lower limit of the pH of the dispersant-containing liquid according to the present disclosure at 20° C. is preferably 7.0, more preferably 7.2, and still more preferably 7.4. Further, the upper limit of the pH of the dispersant-containing liquid according to the present disclosure at 20° C. is preferably 10.0, more preferably 9.0, and still more preferably 8.6.

In this manner, a more suitable dissolved state of the water-soluble polyester can be ensured, and thus, for example, problems of aggregation, sedimentation, and the like due to insolubilization of the water-soluble polyester can be more effectively prevented. As a result, for example, the dispersion stability of the organic coloring material and the drying resistance of the aqueous coloring material dispersion liquid when the aqueous coloring material dispersion liquid in which the organic coloring material is dispersed is prepared by using the dispersant-containing liquid can be further improved. Further, when the aqueous coloring material dispersion liquid is an ink jet composition, the jetting stability of the ink jet composition using an ink jet method can be further improved.

The dispersant-containing liquid of the present disclosure can be suitably prepared, for example, by adding required components such as water and polyalkylene glycols to the water-soluble polyester obtained by a condensation reaction, and stirring the mixture. Further, the mixture may be heated as necessary when the mixture is stirred.

### <2> Aqueous Coloring Material Dispersion Liquid

Next, the aqueous coloring material dispersion liquid of the present disclosure will be described.

The aqueous coloring material dispersion liquid of the present disclosure contains anionic water-soluble polyester containing a carboxylate and/or a sulfonate, polyalkylene glycols, water, and at least one organic coloring material selected from the group consisting of a pigment, a disperse dye, and an oil-soluble dye.

In this manner, the aqueous coloring material dispersion liquid with excellent dispersion stability of the organic coloring material and excellent storage stability can be provided. Further, the drying resistance of the aqueous coloring material dispersion liquid can be improved. Further, even when the aqueous coloring material dispersion liquid contains a moisturizer and a surface tension adjuster, the affinity and the adsorptivity for the organic coloring material do not compete with each other between the moisturizer and the surface tension adjuster, and thus the dispersion stability of the organic coloring material is not adversely affected, which is suitable.

### <2-1> Water

The aqueous coloring material dispersion liquid of the present disclosure contains water. The water mainly has a function of imparting fluidity to the aqueous coloring material dispersion liquid and functions as a dispersion medium and a solvent.

It is preferable to use ion exchange water, pure water, or ultrapure water as water.

The lower limit of the content of water in the aqueous coloring material dispersion liquid is not particularly limited, but is preferably 35.0% by mass, more preferably 40.0% by mass, and still more preferably 45.0% by mass. Further, the upper limit of the content of water in the dispersant-containing liquid is not particularly limited, but is preferably 95.0% by mass, more preferably 93.0% by mass, and still more preferably 90.0% by mass.

In this manner, the viscosity of the aqueous coloring material dispersion liquid can be more reliably adjusted to a suitable value. Further, the dispersion stability of the organic coloring material in the aqueous coloring material dispersion liquid can be further improved.

### <2-2> Water-Soluble Polyester Serving as Dispersant

The aqueous coloring material dispersion liquid of the present disclosure contains the water-soluble polyester containing a carboxylate and/or a sulfonate as a dispersant.

It is preferable that such water-soluble polyester satisfy the same conditions as described in the section <1-2> above.

In this manner, the same effects as described above can be obtained.

The lower limit of the content of the water-soluble polyester in the aqueous coloring material dispersion liquid is preferably 0.3% by mass, more preferably 0.4% by mass, and still more preferably 0.5% by mass. Further, the upper limit of the content of the water-soluble polyester in the aqueous coloring material dispersion liquid is preferably 17.5% by mass, more preferably 15.0% by mass, and still more preferably 14.0% by mass.

In this manner, the dispersion stability of the organic coloring material and the drying resistance of the aqueous coloring material dispersion liquid can be further improved. Further, the viscosity of the aqueous coloring material dispersion liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

Further, the lower limit of the content of the water-soluble polyester is preferably 10.0 parts by mass, more preferably 15.0 parts by mass, and still more preferably 20.0 parts by mass with respect to 100.0 parts by mass of the organic coloring material contained in the aqueous coloring material dispersion liquid. Further, the upper limit of the content of the water-soluble polyester is preferably 200.0 parts by mass, more preferably 150.0 parts by mass, and still more preferably 90.0 parts by mass with respect to 100.0 parts by mass of the organic coloring material contained in the aqueous coloring material dispersion liquid.

In this manner, the viscosity of the aqueous coloring material dispersion liquid is likely to be adjusted to be in a suitable range, the handleability of the aqueous coloring material dispersion liquid can be further improved, and the dispersion stability of the organic coloring material and the drying resistance of the aqueous coloring material dispersion liquid can be further improved.

### <2-3> Polyalkylene Glycols

The aqueous coloring material dispersion liquid of the present disclosure contains polyalkylene glycols.

It is preferable that such polyalkylene glycols satisfy the same conditions as described in the section <1-3> above.

In this manner, the same effects as described above can be obtained.

The lower limit of the content of the polyalkylene glycols in the aqueous coloring material dispersion liquid is preferably 0.01% by mass, more preferably 0.03% by mass, and still more preferably 0.05% by mass. Further, the upper limit of the content of the polyalkylene glycols in the aqueous coloring material dispersion liquid is preferably 10.0% by mass, more preferably 5.0% by mass, and still more preferably 1.5% by mass.

In this manner, the dispersion stability of the organic coloring material and the drying resistance of the aqueous coloring material dispersion liquid can be further improved. Further, the viscosity of the aqueous coloring material dispersion liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

When the content of the water-soluble polyester in the aqueous coloring material dispersion liquid is defined as XPEs [mass %] and the content of the polyalkylene glycols in the aqueous coloring material dispersion liquid is defined as XPAG [mass %], it is preferable to satisfy a relationship of 0.01≤XPAG/XPEs≤2.00, more preferable to satisfy a relationship of 0.03≤XPAG/XPEs≤1.00, and still more preferable to satisfy a relationship of 0.05≤XPAG/XPEs≤0.50.

In this manner, the dispersion stability of the organic coloring material in the aqueous coloring material dispersion liquid and the drying resistance of the aqueous coloring material dispersion liquid can be further improved. Further, the viscosity of the aqueous coloring material dispersion liquid can be adjusted to be in a more suitable range, and for example, when the aqueous coloring material dispersion liquid is an ink jet composition, the color developability of the recorded portion formed by using the ink jet composition can be further improved while the jetting stability of the ink jet composition using an ink jet method is further improved.

### <2-4> Organic Coloring Material

The aqueous coloring material dispersion liquid of the present disclosure contains at least one organic coloring material selected from the group consisting of a pigment, a disperse dye, and an oil-soluble dye.

Examples of the pigment include a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, an azo-based pigment, and carbon black.

More specifically, examples of a yellow pigment include C.I. Pigment Yellow 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, and 180. Examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53, 53:1, 55, 57 (Ca), 57:1, 60, 60:1, 63:1, 63:2, 64, 64:1, 81, 83, 87, 88, 89, 90, 101, 104, 105, 106, 108, 112, 114, 122, 123, 146, 149, 163, 166, 168, 170, 172, 177, 178, 179, 184, 185, 190, 193, 202, 209, and 219. Examples of a cyan pigment include C.I. Pigment Blue 1, 2, 3, 15, 15:1, 15:2, 15:3, 15:34, 16, 17:1, 22, 25, 56, and 60, and C.I. Vat Blue 4, 60, and 63. Examples of other color pigments include C.I. Pigment Orange 5, 13, 16, 17, 36, 43, and 51, C.I. Pigment Green 1, 4, 7, 8, 10, 17, 18, and 36, and C.I. Pigment Violet 1, 3, 5:1, 16, 19, 23, and 38.

Examples of the disperse dye include C.I. Disperse Red 60, 82, 86, 86:1, 167:1, 279, and 364, C.I. Disperse Yellow 54, 64, 71, 86, 114, 153, 232, 233, and 245, C.I. Disperse Blue 27, 60, 73, 77, 77:1, 87, 257, 359, and 367, C.I. Disperse Violet 26, 33, 36, and 57, and C.I. Disperse Orange 30, 41, and 61.

Examples of the oil-soluble dye include C.I. Solvent Yellow 16, 21, 25, 29, 33, 51, 56, 82, 88, 89, 150, 160:1, and 163, C.I. Solvent Red 7, 8, 18, 24, 27, 49, 109, 122, 125, 127, 130, 132, 135, 218, 225, and 230, C.I. Solvent Blue 14, 25, 35, 38, 48, 67, 68, 70, and 132, and C.I. Solvent Black 3, 5, 7, 27, 28, 29, and 34.

It is preferable that the organic coloring material contained in the aqueous coloring material dispersion liquid of the present disclosure be any of the disperse dye or the oil-soluble dye.

In this manner, the dispersion stability of the organic coloring material in the aqueous coloring material dispersion liquid can be further improved. Further, the aqueous coloring material dispersion liquid of the present disclosure can be suitably applied to an ink jet composition, and the color developability and the like of the recorded portion formed by using the ink jet composition can be further improved.

The lower limit of the average particle diameter of the organic coloring material contained in the aqueous coloring material dispersion liquid of the present disclosure is preferably 80 nm, more preferably 85 nm, and still more preferably 90 nm. Further, the upper limit of the average particle diameter of the organic coloring material contained in the aqueous coloring material dispersion liquid of the present disclosure is preferably 180 nm, more preferably 150 nm, and still more preferably 120 nm.

In this manner, the dispersion stability of the organic coloring material in the aqueous coloring material dispersion liquid and the storage stability of the aqueous coloring material dispersion liquid can be further improved.

Further, in the present specification, the average particle diameter denotes the average particle diameter in terms of the volume unless otherwise specified. Further, the average particle diameter can be determined by performing measurement using, for example, MICROTRAC UPA (manufactured by Nikkiso Co., Ltd.).

The content of the organic coloring material in the aqueous coloring material dispersion liquid of the present disclosure is not particularly limited, but the lower limit of the content of the organic coloring material in the aqueous coloring material dispersion liquid of the present disclosure is preferably 0.5% by mass, more preferably 1.0% by mass, and still more preferably 1.5% by mass. Further, the upper limit of the content of the organic coloring material in the aqueous coloring material dispersion liquid of the present disclosure is preferably 30.0% by mass, more preferably 25.0% by mass, and still more preferably 20.0% by mass.

In this manner, the dispersion stability of the organic coloring material can be further improved while the content of the organic coloring material in the aqueous coloring material dispersion liquid is sufficiently increased. Further, the viscosity of the aqueous coloring material dispersion liquid to be obtained is likely to be adjusted to be in a more suitable range when the organic coloring material is dispersed using, for example, a disperser such as a bead mill. Further, when the aqueous coloring material dispersion liquid is an ink composition such as an ink jet composition, the jetting stability of the ink composition and the color developability of the recorded portion formed using the ink composition can be further improved.

### <2-5> Basic Substance

The aqueous coloring material dispersion liquid of the present disclosure may contain a basic substance as a pH adjuster.

In this manner, the pH of the aqueous coloring material dispersion liquid can be adjusted to be in a suitable range, a more suitable dissolved state of the water-soluble polyester in the aqueous coloring material dispersion liquid can be ensured, and thus, for example, problems of aggregation, sedimentation, and the like due to insolubilization of the water-soluble polyester can be more effectively prevented. As a result, for example, the dispersion stability of the organic coloring material in the aqueous coloring material dispersion liquid and the drying resistance of the aqueous coloring material dispersion liquid can be further improved. Further, when the aqueous coloring material dispersion liquid is an ink jet composition, the jetting stability of the ink jet composition using an ink jet method can be further improved.

It is preferable that such a basic substance satisfy the same conditions as described in the section <1-4>.

In this manner, the same effects as described above can be obtained.

### <2-6> Moisturizer

The aqueous coloring material dispersion liquid of the present disclosure may contain a moisturizer.

Examples of the moisturizer include polyols such as diethylene glycol, triethylene glycol, tetraethylene glycol, pentaethylene glycol, trimethylene glycol, 2-butene-1,4-diol, 2-ethyl-1,3-hexanediol, 2-methyl-2,4-pentanediol, tripropylene glycol, isobutylene glycol, glycerin, diglycerin, mesoerythritol, trimethylolpropane, ditrimethylolpropane, pentaerythritol, and dipentaerythritol, saccharides such as monosaccharides, disaccharides, oligosaccharides, and polysaccharides, such as glucose, mannose, fructose, ribose, xylose, arabinose, galactose, aldonic acid, glucitol (sorbitol), maltose, cellobiose, lactose, sucrose, trehalose, and maltotriose, and derivatives of these saccharides, and betaines such as glycine and trimethyl glycine. Further, the moisturizer can be used alone or in combination of two or more kinds selected from these.

The content of the moisturizer in the aqueous coloring material dispersion liquid of the present disclosure is not particularly limited, but the lower limit of the content of the moisturizer in the aqueous coloring material dispersion liquid of the present disclosure is preferably 0.2% by mass, more preferably 0.5% by mass, and still more preferably 0.7% by mass. Further, the upper limit of the content of the moisturizer in the aqueous coloring material dispersion liquid of the present disclosure is preferably 20.0% by mass, more preferably 15.0% by mass, and still more preferably 10.0% by mass.

### <2-7> Surface Tension Adjuster

The aqueous coloring material dispersion liquid of the present disclosure may contain a surface tension adjuster.

Examples of the surface tension adjuster include a surfactant.

Particularly, in a case where the aqueous coloring material dispersion liquid of the present disclosure contains the moisturizer and the surface tension adjuster when the aqueous coloring material dispersion liquid is an ink jet ink, an effect of more stably jetting the ink by decreasing the evaporation speed using the excellent moisturizing ability can be obtained.

Examples of the surfactant include a cationic surfactant, an anionic surfactant, and a nonionic surfactant, but a nonionic surfactant is particularly preferable from the viewpoint of suppressing the influence on the solubility of the water-soluble polyester that is anionically dissolved.

Examples of a nonionic non-reactive surfactant include a silicone-based surfactant, a fluorine-based surfactant, and an acetylene glycol-based surfactant.

Examples of the silicone-based surfactant include BYK-306, BYK-307, BYK-333, BYK-341, BYK-345, BYK-346, BYK-348, BYK-349, and BYK-3455 (all manufactured by BYK Japan K.K.), SILFACE SAG503A, SAG002, SAG005, and SAG014 (all manufactured by Nissin Chemical Co., Ltd.), KF-351A, KF-352A, KF-353, KF-354L, KF-355A, KF-615A, KF-945, KF-640, KF-642, KF-643, KF-6020, X-22-4515, KF-6011, and KF-6012 (all manufactured by Shin-Etsu Chemical Co., Ltd.).

Examples of the fluorine-based surfactant include FC-4430 and FC-4432 (both manufactured by 3M Japan Limited), MEGAFACE F-444, F-477, F-553, and F-556 (all manufactured by DIC Corporation), and SURFLON S-241, S-242, S-243, and S-386 (all manufactured by AGC Seimi Chemical Co., Ltd.).

Examples of the acetylene glycol-based surfactant include SURFYNOL 82, 465, 485, and 2502, OLFINE E1004, E1010, E1020, PD-002W, PD-004, EXP4001, EXP4002, EXP4123, and EXP4300 (all manufactured by Nissin Chemical Co., Ltd.), and ACETYLENOL E00, E103T, E40, E60, E100, and E200 (all manufactured by Kawaken Fine Chemicals Co., Ltd.).

Further, examples of the surface tension adjuster include water-soluble compounds, for example, lower alcohol such as 2-propanol, 1-propanol, 2-butanol, or 1-butanol, glycol monoethers such as diethylene glycol monobutyl ether, triethylene glycol monobutyl ether, propylene glycol monobutyl ether, dipropylene glycol monobutyl ether, ethylene glycol mono-2-ethyl hexyl ether, and diethylene glycol mono-2-ethylhexyl ether, 1,2-diols such as 1,2-pentanediol and 1,2-hexanediol, and glycerin monoether such as glycerin monobutyl ether or glycerin-2-ethylhexyl ether.

The content of the surface tension adjuster in the aqueous coloring material dispersion liquid of the present disclosure is not particularly limited, but the lower limit of the content of the surface tension adjuster in the aqueous coloring material dispersion liquid of the present disclosure is preferably 0.1% by mass, more preferably 0.2% by mass, and still more preferably 0.3% by mass. Further, the upper limit of the content of the surface tension adjuster in the aqueous coloring material dispersion liquid of the present disclosure is preferably 10.0% by mass, more preferably 8.0% by mass, and still more preferably 6.0% by mass.

### <2-8> Other Components

The aqueous coloring material dispersion liquid of the present disclosure may further contain components other than the above-described components. Hereinafter, such components will be referred to as “other components” in this section.

Examples of other components include preservatives, chelating agents, dispersants and resin components other than the water-soluble polyester, and solvents other than water, and the other components can be used alone or in combination of two or more kinds selected from these.

When the aqueous coloring material dispersion liquid contains a preservative, for example, putrefaction of the aqueous coloring material dispersion liquid due to microorganisms can be prevented, and precipitation and aggregation of the solid content in the aqueous coloring material dispersion liquid can be more effectively prevented.

Examples of the preservative include methylisothiazolinone, chloromethylisothiazolinone, octylisothiazolinone, dichlorooctylisothiazolinone, benzisothiazolinone, dicyclohexylamine, iodopropynyl butylcarbamate, and diethylene oximide.

When the aqueous coloring material dispersion liquid contains a chelating agent, for example, polyvalent cations in the aqueous coloring material dispersion liquid are trapped, and precipitation and aggregation of the solid content in the aqueous coloring material dispersion liquid can be more effectively prevented.

Examples of the chelating agent include ethylenediaminetetraacetate, diethylenetriaminetetraacetate, pentetate, iminodisuccinate, and aspartic acid diacetate.

Here, the content of the other components in the aqueous coloring material dispersion liquid of the present disclosure is preferably 10.0% by mass or less, more preferably 5.0% by mass or less, and still more preferably 3.0% by mass or less.

### <2-9> Other Conditions

It is preferable that the aqueous coloring material dispersion liquid of the present disclosure satisfy the conditions described below.

For example, the lower limit of the pH of the aqueous coloring material dispersion liquid according to the present disclosure at 20° C. is preferably 7.0, more preferably 7.2, and still more preferably 7.4. Further, the upper limit of the pH of the aqueous coloring material dispersion liquid according to the present disclosure at 20° C. is preferably 10.0, more preferably 9.0, and still more preferably 8.6.

In this manner, a more suitable dissolved state of the water-soluble polyester can be ensured, and thus, for example, problems of aggregation, sedimentation, and the like due to insolubilization of the water-soluble polyester can be more effectively prevented. As a result, for example, the dispersion stability of the organic coloring material in the aqueous coloring material dispersion liquid and the drying resistance of the aqueous coloring material dispersion liquid can be further improved. Further, when the aqueous coloring material dispersion liquid is an ink jet composition, the jetting stability of the ink jet composition using an ink jet method can be further improved.

The aqueous coloring material dispersion liquid of the present disclosure may be used for any applications such as a coating material or various ink compositions, but it is preferable that the aqueous coloring material dispersion liquid be an ink jet composition, particularly an ink jet ink.

In an ink jet ink, sedimentation or aggregation of the organic coloring material in the composition, precipitation of the solid content in an ink jet head or a flow path, and the like greatly affect the jetting stability using an ink jet method, and in some cases, jetting of the composition using an ink jet method may be impossible to carry out. That is, the ink jet composition is required to have both the dispersion stability and the drying resistance of the organic coloring material at higher levels. On the contrary, in the present disclosure, both the dispersion stability and the drying resistance of the organic coloring material can be suitably achieved. That is, the effects of the present disclosure are more remarkably exhibited when the aqueous coloring material dispersion liquid is an ink jet ink. Further, in the present specification, the concept of the ink jet composition includes a stock solution and the like of an ink jet ink, which are used to prepare an ink jet ink by being mixed with other components, in addition to an ink jet ink itself to be jetted by an ink jet method.

The lower limit of the viscosity of the aqueous coloring material dispersion liquid of the present disclosure at 20° C. is not particularly limited, but is preferably 2.0 mPa·s and more preferably 3.0 mPa·s. Further, the upper limit of the viscosity of the aqueous coloring material dispersion liquid of the present disclosure at 20° C. is not particularly limited, but is preferably 9.0 mPa·s, more preferably 8.0 mPa·s, and still more preferably 7.0 mPa·s.

In this manner, for example, when the aqueous coloring material dispersion liquid of the present disclosure is an ink jet composition, the jetting stability thereof can be further improved.

Further, the viscosity can be measured by increasing the shear rate from 10 [s⁻¹] to 1,000 [s⁻¹] at 20° C. using a viscoelasticity tester such as MCR-300 (manufactured by Physica) and reading the viscosity when the shear rate reaches 200.

The lower limit of the surface tension of the aqueous coloring material dispersion liquid of the present disclosure at 20° C. is not particularly limited, but is preferably 20 mN/m, more preferably 21 mN/m, and still more preferably 23 mN/m. Further, the upper limit of the surface tension of the aqueous coloring material dispersion liquid of the present disclosure at 20° C. is not particularly limited, but is preferably 50 mN/m, more preferably 40 mN/m, and still more preferably 30 mN/m.

In this manner, for example, when the aqueous coloring material dispersion liquid of the present disclosure is an ink jet composition, clogging or the like of a nozzle of a recording device using an ink jet method is unlikely to occur, and thus the jetting stability of the aqueous coloring material dispersion liquid of the present disclosure is further improved. Further, even when a nozzle is clogged, recovery properties can be further improved by capping the nozzle.

Further, a value measured by a Wilhelmy method can be employed as the surface tension. The surface tension can be measured by using, for example, a surface tension meter such as CBVP-7 (manufactured by Kyowa Interface Science Co., Ltd.).

When the aqueous coloring material dispersion liquid of the present disclosure is an ink jet ink, the ink is typically applied to a recording device using an ink jet method in a state of being accommodated in a container such as a cartridge, a bag, or a tank. In other words, the recording device according to the present disclosure includes a container such as an ink cartridge that accommodates an ink jet ink serving as the aqueous coloring material dispersion liquid of the present disclosure.

The aqueous coloring material dispersion liquid of the present disclosure can be prepared by miniaturizing the organic coloring material using a bead mill or the like in a state where the above-described dispersant-containing liquid of the present disclosure is mixed with the organic coloring material that is formed into a dispersoid.

For example, various inorganic beads such as zirconia beads, stainless steel beads, and alumina beads can be suitably used as the beads.

For example, components such as water, a solvent, a moisturizer, and a surface tension adjuster may be used in addition to the dispersant-containing liquid of the present disclosure and the organic coloring material described above when the aqueous coloring material dispersion liquid of the present disclosure is prepared.

The aqueous coloring material dispersion liquid of the present disclosure may be heated as necessary when prepared.

Further, the method of preparing the aqueous coloring material dispersion liquid according to the present disclosure is not limited to the above-described method. For example, the aqueous coloring material dispersion liquid of the present disclosure may be prepared by mixing required components such as the water-soluble polyester obtained by a condensation reaction, the organic coloring material, the polyalkylene glycols, and water at once or sequentially adding and mixing the required components in predetermined order without using the above-described dispersant-containing liquid of the present disclosure and miniaturizing the organic coloring material with a bead mill or the like.

Hereinbefore, the suitable embodiments of the present disclosure have been described, but the present disclosure is not limited thereto.

### EXAMPLES

Next, specific examples of the present disclosure will be described.

### <3> Synthesis of Water-Soluble Polyester

### Synthesis Example 1

An autoclave provided with a thermometer and a stirrer was charged with 33 parts by weight of dimethyl terephthalate, 19 parts by weight of dimethyl isophthalate, 35 parts by weight of dimethyl adipate, 5 parts by weight of sodium dimethyl 5-sulfoisophthalate, 14 parts by weight of 1,3-propanediol, 28 parts by weight of benzenedimethanol, 10 parts by weight of neopentyl glycol, and 0.5 parts by weight of tetrabutoxy titanate serving as a catalyst, heated at 150° C. to 200° C. for 180 minutes, and subjected to a transesterification reaction.

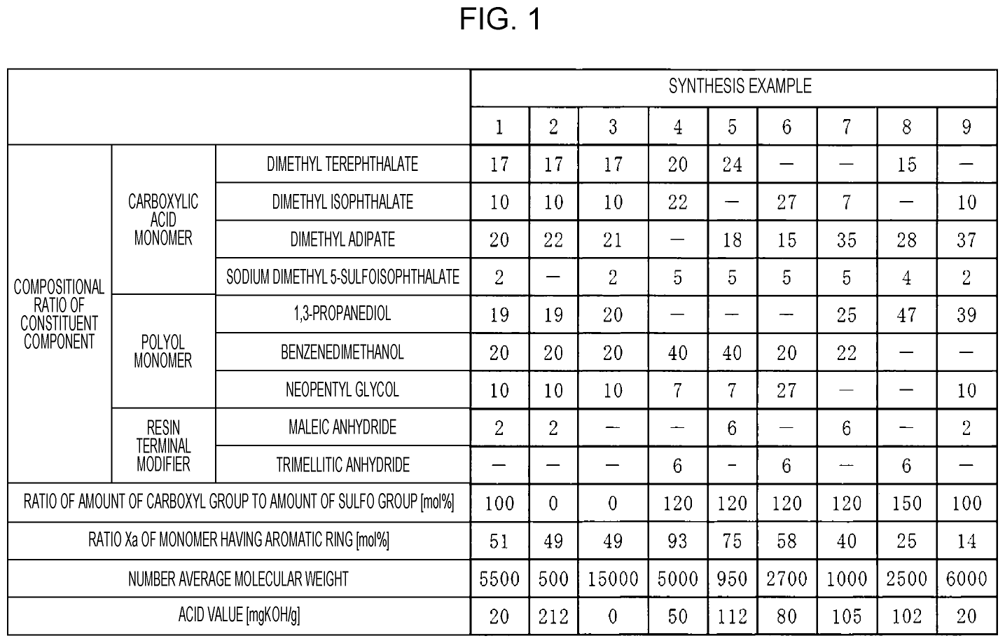

Next, the pressure of the system was gradually reduced at a temperature of 200° C. to distill off diol components, the pressure thereof was set to 10 mmHg after 30 minutes, and a polymerization reaction was continued for 90 minutes. Next, 2 parts by weight of maleic acid serving as a resin terminal modifier was added to the reactant, the mixture was allowed to further react for 60 minutes at 200° C., and a carboxyl group was introduced to a polyester terminal, thereby obtaining water-soluble polyester under the conditions shown in FIG. 1.

The number average molecular weight of the obtained water-soluble polyester was 5,500, the acid value thereof was 20 mgKOH/g, the molar ratio [mol %] of the amount of the carboxyl group to the amount of the sulfo group in the water-soluble polyester was 100 mol %, and a ratio Xa [mol %] of the monomer having an aromatic ring to all monomers of the water-soluble polyester was 51 mol %.

In addition, the number average molecular weight of the obtained water-soluble polyester was measured by GPC. Further, the ratio of the monomer to all monomers in the water-soluble polyester was measured by 1H-NMR. The amount of the sulfo group was calculated by measuring the amount of sulfur using XRF. The amount of the carboxyl group was calculated from the acid value of the water-soluble polyester. The number average molecular weight, the ratio of the monomer to all monomers in the water-soluble polyester, the amount of the sulfo group, and the amount of the carboxyl group for water-soluble polyesters synthesized in the following synthesis examples were determined in the same manners as described above.

### Synthesis Examples 2 to 17

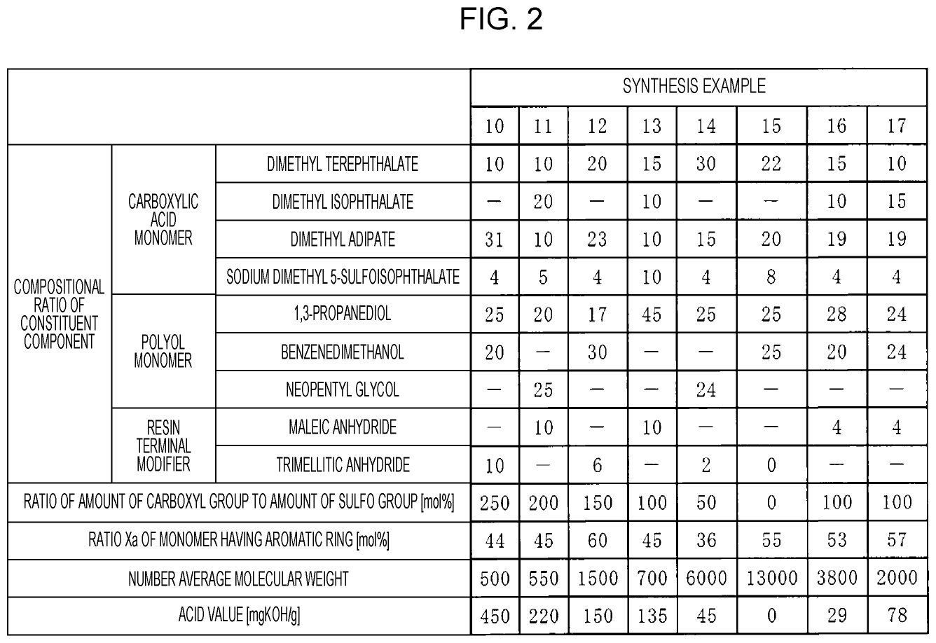

Water-soluble polyesters were obtained in the same manner as in Synthesis Example 1 except that the kinds and the used amounts of the raw material monomers used in the synthesis of the water-soluble polyesters were changed to satisfy the conditions shown in FIGS. 1 and 2.

The conditions of the water-soluble polyesters obtained in Synthesis Examples 1 to 17 are collectively shown in FIGS. 1 and 2. Further, the numerical values in the columns of the compositional ratios in FIGS. 1 and 2 denote the ratios in the water-soluble polyester in units of mol %.

### <4> Preparation of Dispersant-Containing Liquid

### Example A1

10.0 parts by mass of the water-soluble polyester synthesized in Synthesis Example 1, 50.0 parts by mass of pure water, and 1.0 parts by mass of ADEKA PLURONIC P-85 (“PLURONIC” (registered trademark), manufactured by ADEKA Corporation) as polyalkylene glycols were added to a flask, and 5.0 parts by mass of triethanolamine as a basic substance was added thereto. Thereafter, pure water was added to the mixture such that the total amount thereof reached 100.0 parts by mass, and the mixture was stirred at 70° C. for 60 minutes, thereby obtaining a uniform dispersant-containing liquid.

### Examples A2 to A31

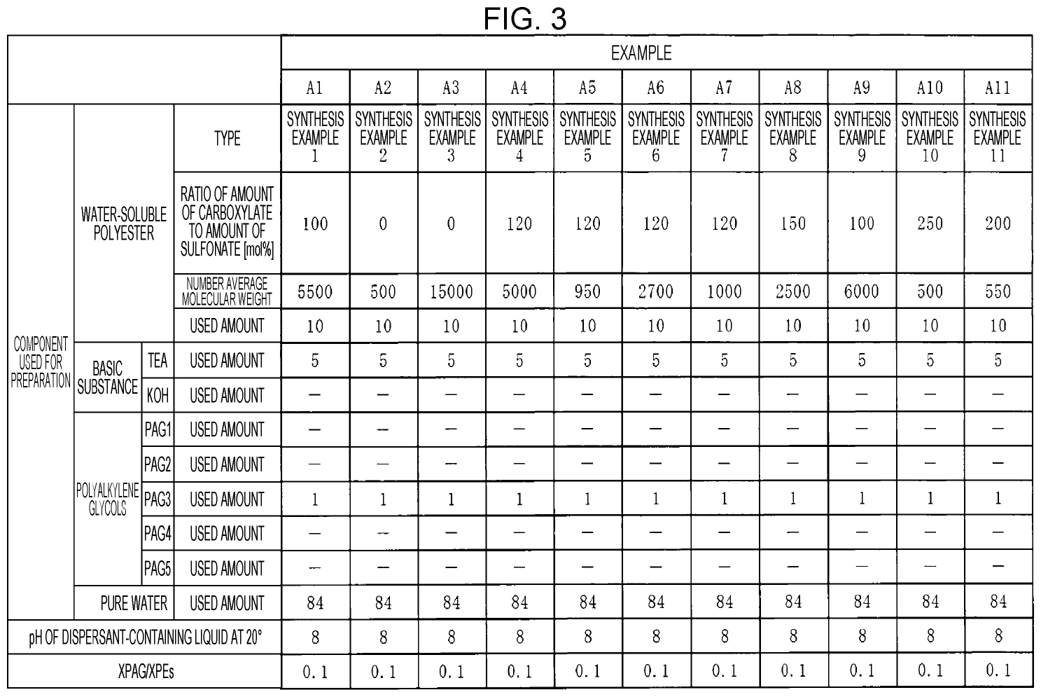

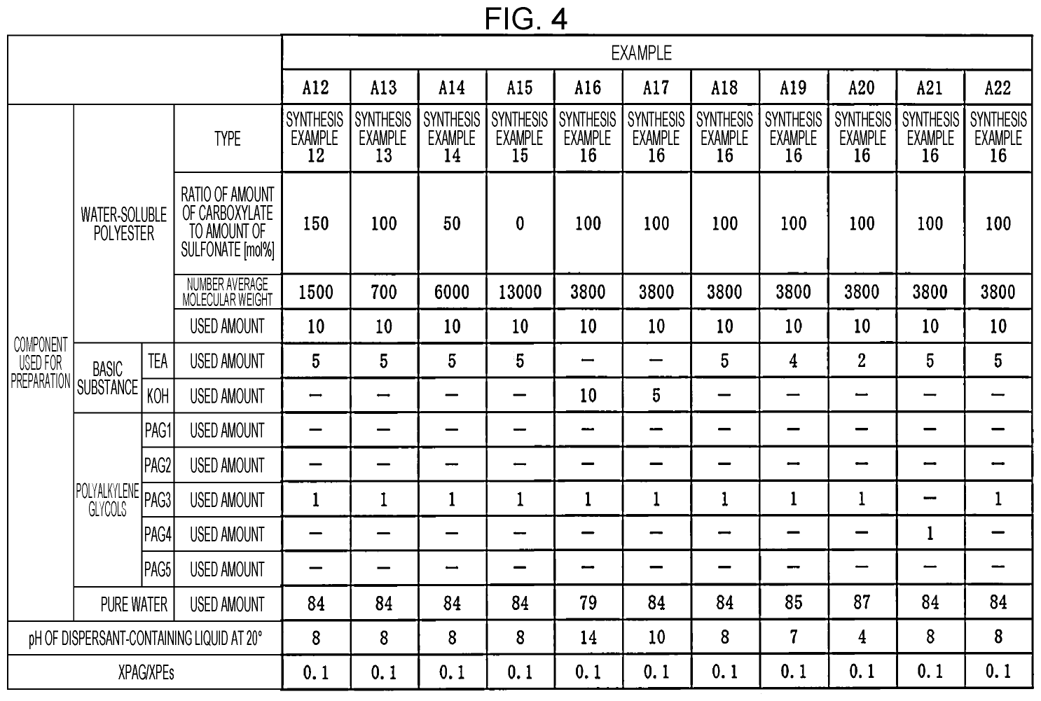

Dispersant-containing liquids were prepared in the same manner as in Example A1 except that the kinds and the used amounts of the components used for the preparation of the dispersant-containing liquids were changed as shown in FIGS. 3 to 5.

### Comparative Examples A1 and A2

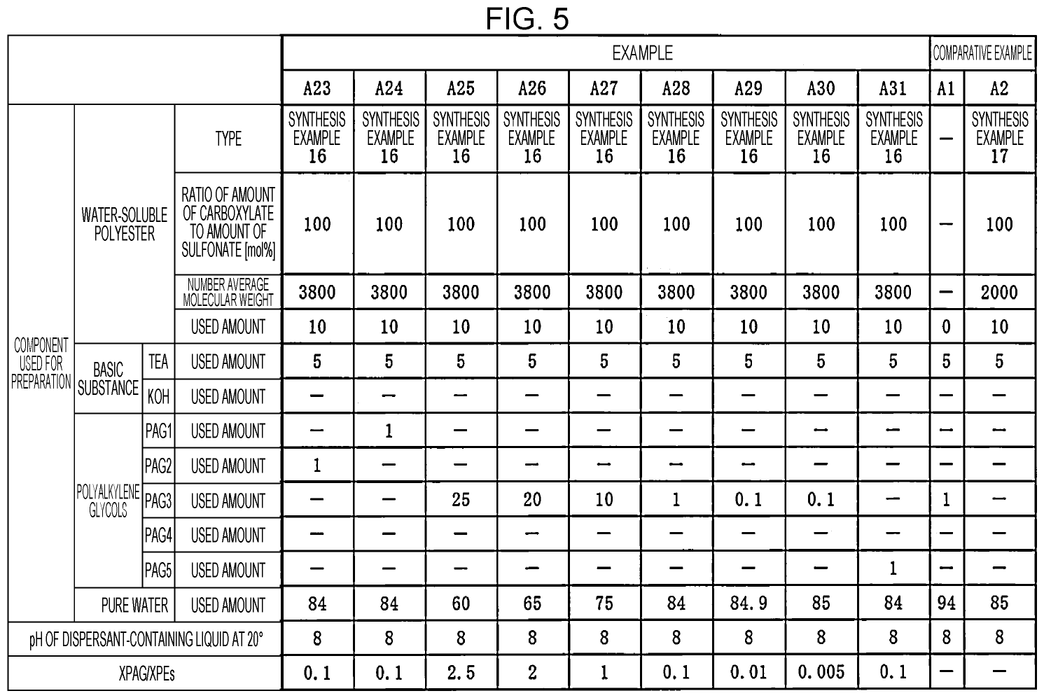

Dispersant-containing liquids were prepared in the same manner as in Example A1 except that the kinds and the used amounts of the components used for the preparation of the dispersant-containing liquids were changed as shown in FIG. 5.

The conditions for the dispersant-containing liquids according to Examples A1 to A31 and Comparative Examples A1 and A2 are collectively shown in FIGS. 3 to 5. Further, the numerical values in the columns of “used amount” of “component used for preparation” in FIGS. 3 to 5 denote the used amounts of the components in units of parts by mass. Further, in FIGS. 3 to 5, “PAG1” denotes NEWPOL PE-62 (manufactured by Sanyo Chemical Industries, Ltd.) as the polyalkylene glycols represented by Formula (1), “PAG2” denotes ADEKA PLURONIC P-103 (“PLURONIC” (registered trademark), manufactured by ADEKA Corporation) as the polyalkylene glycols represented by Formula (1), “PAG3” denotes ADEKA PLURONIC P-85 (“PLURONIC” (registered trademark), manufactured by ADEKA Corporation) as the polyalkylene glycols represented by Formula (1), “PAG4” denotes NEWPOL PE-108 (manufactured by Sanyo Chemical Industries, Ltd.) as the polyalkylene glycols represented by Formula (1), “PAG5” denotes NEWPOL 50HB-660 (manufactured by Sanyo Chemical Industries, Ltd.) as the polyalkylene glycols represented by Formula (1), and “TEA” denotes triethanolamine as the basic substance. PAG1 has a clouding point of 30° C., PAG2 has a clouding point of 67° C., PAG3 has a clouding point of 75° C., PAG4 has a clouding point of 105° C., and PAG5 has a clouding point of 125° C.

### <5> Preparation of Stock Solution of Ink Jet Ink as Aqueous Coloring Material Dispersion Liquid

### Example B1

50.0 parts by mass of the dispersant-containing liquid prepared in Example A1 was mixed with 40.0 parts by mass of pure water, 10.0 parts by mass of a disperse dye C.I. Pigment Blue 15:3 as a coloring material was added to the mixture, the mixture was dispersed in a bead mill for 0.5 hours using zirconia balls having a diameter of 0.5 mm as a medium, the beads were separated, and the mixture was filtered through a filter having a pore size of 8 μm, thereby obtaining a stock solution of an ink jet ink as an aqueous coloring material dispersion liquid.

### Examples B2 to B33

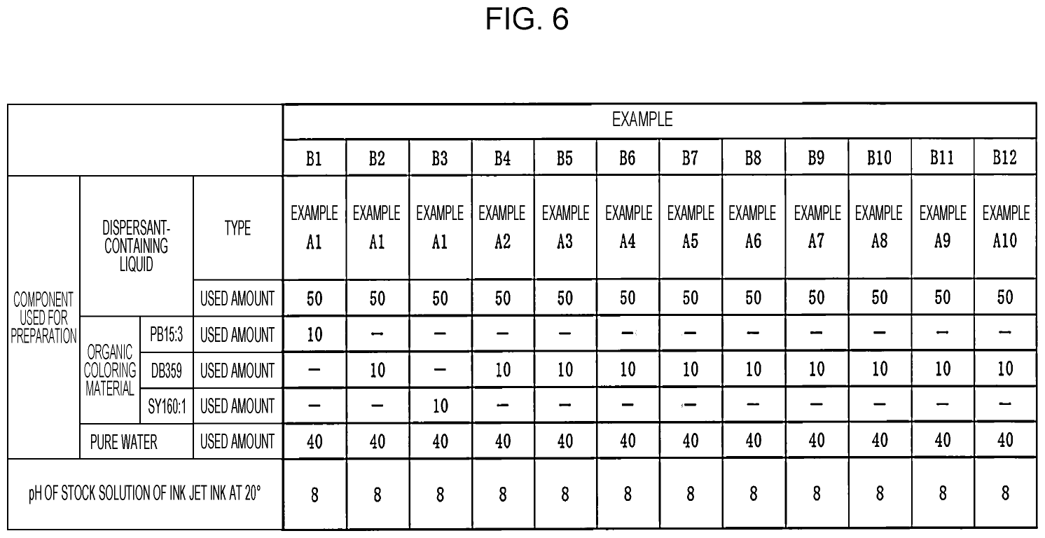

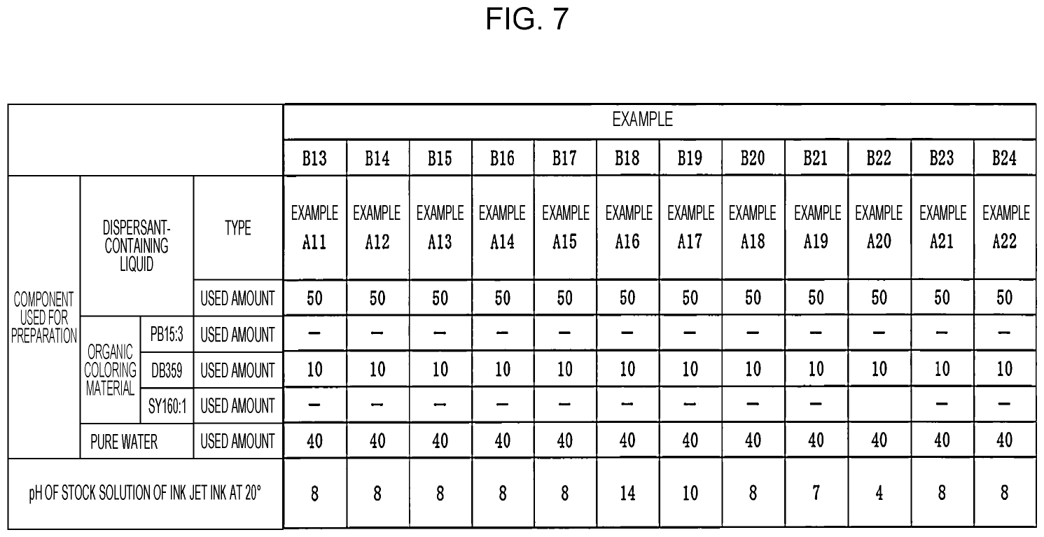

Stock solutions of ink jet inks as aqueous coloring material dispersion liquids were prepared in the same manner as in Example B1 except that the kinds of the dispersant-containing liquids and the kinds of the coloring materials used for preparation of the stock solutions of ink jet inks were changed as shown in FIGS. 6 to 8.

### Comparative Examples B1 and B2

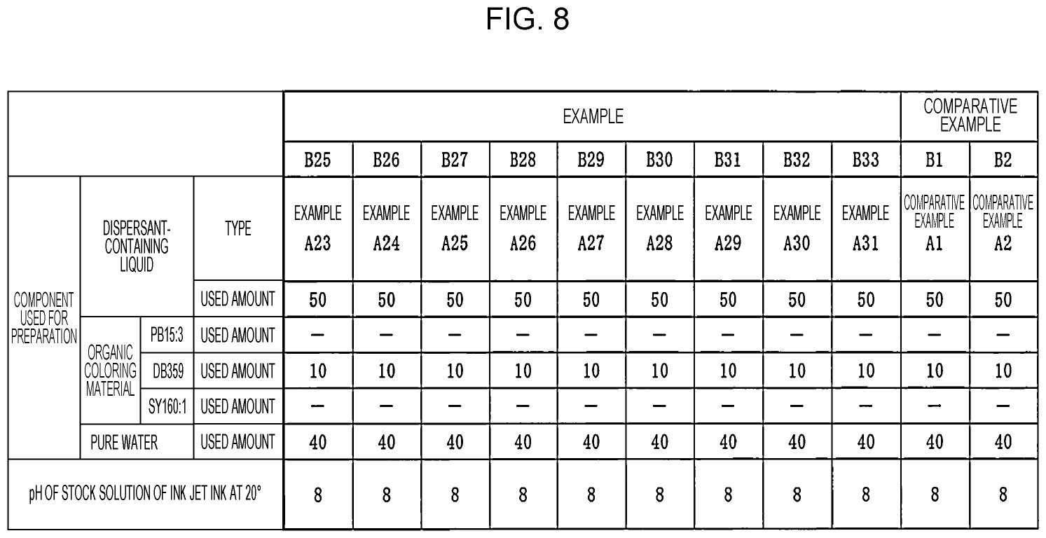

Stock solutions of ink jet inks as aqueous coloring material dispersion liquids were prepared in the same manner as in Example B1 except that the kinds of the dispersant-containing liquids and the kinds of the coloring materials used for preparation of the stock solutions of ink jet inks were changed as shown in FIG. 8.

The conditions of the stock solutions of ink jet inks according to Examples B1 to B33 and Comparative Examples B1 and B2 are collectively shown in FIGS. 6 to 8. Further, the numerical values in the columns of “used amount” of “component used for preparation” in FIGS. 6 to 8 denote the used amounts of the components in units of parts by mass. Further, in FIGS. 6 to 8, “PB15:3” denotes C.I. Pigment Blue 15:3, “DB359” denotes C.I. Disperse Blue 359, and “SY160:1” denotes C.I. Solvent Yellow 160:1. Further, in the stock solutions of ink jet inks in the examples described above, the average particle diameters of the organic coloring materials contained in the stock solutions of the ink jet inks were all in a range of 80 nm or greater and 180 nm or less.

### <6> Preparation of Ink Jet Ink as Aqueous Coloring Material Dispersion Liquid

### Example C1

30.0 parts by mass of the stock solution of an ink jet ink which had been prepared in Example B1, 0.8 parts by mass of triethylene glycol as a moisturizer, 0.4 parts by mass of trimethylolpropane as a moisturizer, 0.6 parts by mass of BYK-348 (manufactured by BYK Japan K.K.) as a surface tension adjuster, and 0.5 parts by mass of 1,2-hexanediol as a surface tension adjuster were mixed with each other, pure water was added to the mixture such that the total amount thereof reached 100.0 parts by mass, and the mixture was stirred in an environment of 20° C. for 30 minutes and filtered by a microfiltration filter having a pore size of 3 μm, thereby obtaining an ink jet ink serving as an aqueous coloring material dispersion liquid.

### Examples C2 to C33

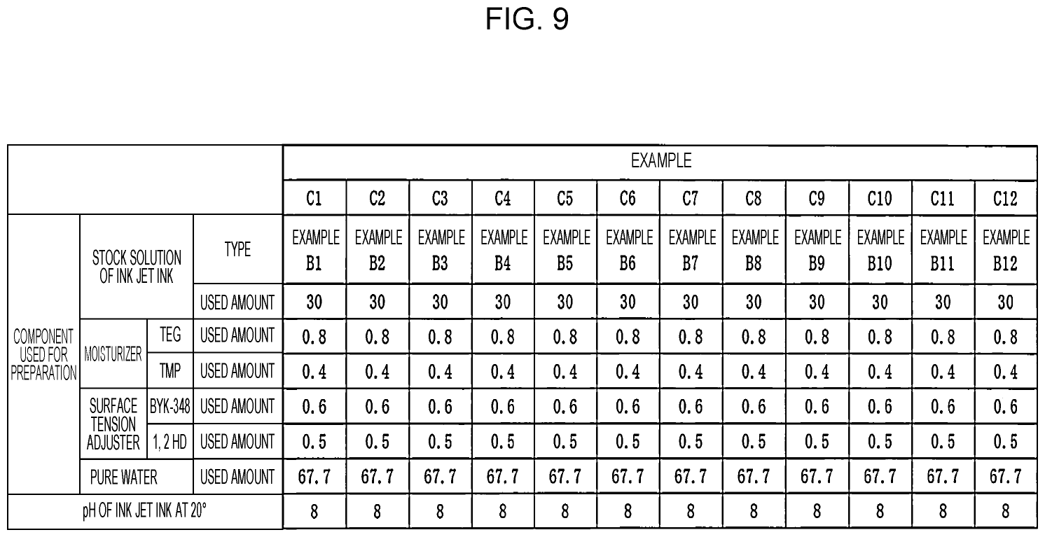

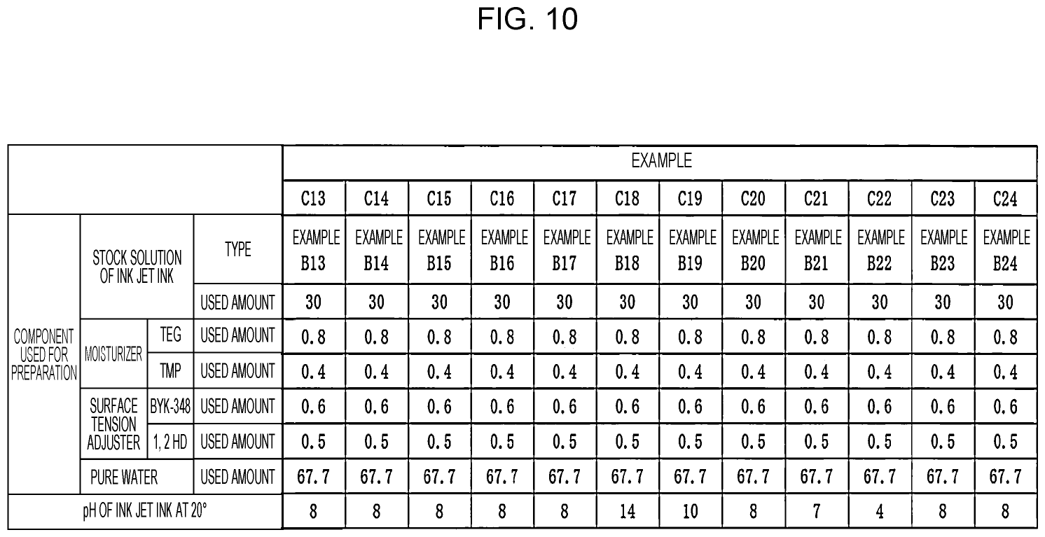

Ink jet inks as aqueous coloring material dispersion liquids were prepared in the same manner as in Example C1 except that the kinds of the stock solutions of ink jet inks and the kinds of the added components used for preparation of ink jet inks were changed as shown in FIGS. 9 to 11.

### Comparative Examples C1 and C2

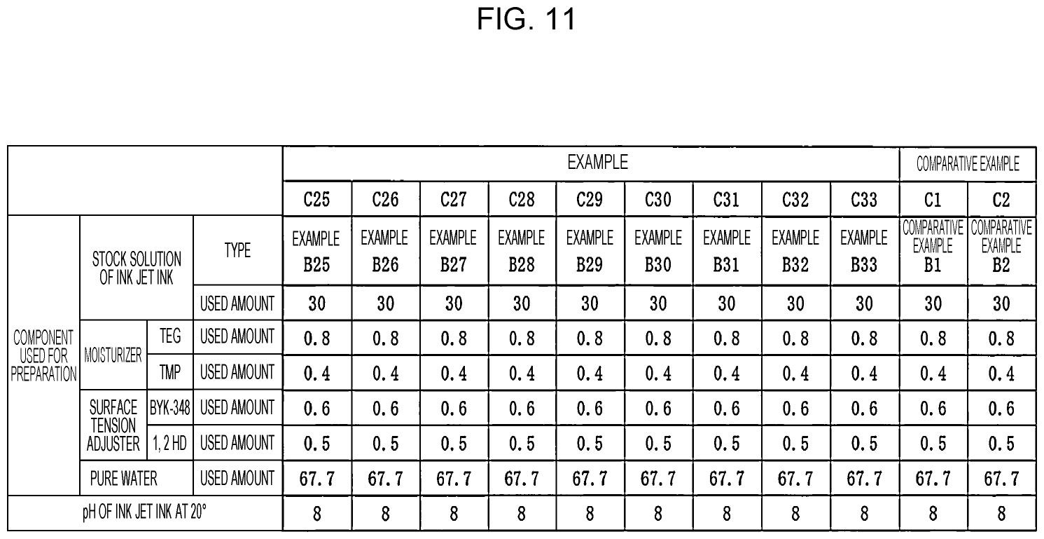

Ink jet inks as aqueous coloring material dispersion liquids were prepared in the same manner as in Example C1 except that the kinds of the stock solutions of ink jet inks and the kinds of the added components used for preparation of ink jet inks were changed as shown in FIG. 11.

The conditions of the ink jet inks according to Examples C1 to C33 and Comparative Examples C1 and C2 are collectively shown in FIGS. 9 to 11. Further, the numerical values in the columns of “used amount” of “component used for preparation” in FIGS. 9 to 11 denote the used amounts of the components in units of parts by mass. Further, in FIGS. 9 to 11, “TEG” denotes triethylene glycol, “PE” denotes pentaerythritol, “TMP” denotes trimethylolpropane, and “1,2HD” denotes 1,2-hexanediol. Further, in the ink jet inks of the examples described above, the average particle diameters of the organic coloring materials contained in the ink jet inks were all in a range of 80 nm or greater and 180 nm or less. The ink jet inks of the above-described examples all had a viscosity of 2.0 mPa·s or greater and 9.0 mPa·s or less. Further, the viscosity was measured by increasing the shear rate from 10 [s⁻¹] to 1,000 [s⁻¹] at 20° C. using a viscoelasticity tester such as MCR-300 (manufactured by Physica) and reading the viscosity when the shear rate reached 200. In addition, the ink jet inks of the above-described examples all had a surface tension of 23 mN/m or greater and 30 mN/m or less. The surface tension was measured at 20° C. by a Wilhelmy method using a surface tension meter (CBVP-7, manufactured by Kyowa Interface Science Co., Ltd.).

### <7> Evaluation

### <7-1> Evaluation of Storage Stability Based on Stability of Viscosity

The stock solutions of ink jet inks of Examples B1 to B33 and Comparative Examples B1 and B2 and the ink jet inks of Examples C1 to C33 and Comparative Examples C1 and C2 were respectively placed in sample container and allowed to stand in an environment of 60° C. for 1 week, the viscosities thereof at 20° C. were measured and compared with the viscosities of the corresponding stock solutions of ink jet inks and the corresponding ink jet inks at 20° C. immediately after the production, and the storage stability was evaluated according to the following evaluation criteria. It can be said that the storage stability is excellent as the rate of fluctuation in the viscosity decreases.
A: The rate of fluctuation in the viscosity from immediately after production was less than 5%.
B: The rate of fluctuation in the viscosity from immediately after production was 5% or greater and less than 10%.
C: The rate of fluctuation in the viscosity from immediately after production was 10% or greater and less than 12%.
D: The rate of fluctuation in the viscosity from immediately after production was 12% or greater and less than 14%.
E: The rate of fluctuation in the viscosity from immediately after production was 14% or greater.

### <7-2> Evaluation of Storage Stability Based on Stability of Particle Diameter

The stock solutions of ink jet inks of Examples B1 to B33 and Comparative Examples B1 and B2 and the ink jet inks of Examples C1 to C33 and Comparative Examples C1 and C2 were respectively placed in sample container and allowed to stand in an environment of 60° C. for 1 week, the average particle diameters of the organic coloring materials in an environment of 20° C. were determined and compared with the average particle diameters of the organic coloring materials contained in the corresponding stock solutions of ink jet inks and the corresponding ink jet inks immediately after the production, and the storage stability was evaluated according to the following evaluation criteria. It can be said that the storage stability increases and the negative impact on the storage stability decreases as the rate of fluctuation in the particle diameter of the organic coloring material decreases. Further, the average particle diameter was measured using MICROTRAC UPA (manufactured by Nikkiso Co., Ltd.).
A: The rate of fluctuation in the average particle diameter of the organic coloring material from immediately after production was less than 2%.
B: The rate of fluctuation in the average particle diameter of the organic coloring material from immediately after production was 2% or greater and less than 5%.
C: The rate of fluctuation in the average particle diameter of the organic coloring material from immediately after production was 5% or greater and less than 7%.
D: The rate of fluctuation in the average particle diameter of the organic coloring material from immediately after production was 7% or greater and less than 9%.
E: The rate of fluctuation in the average particle diameter of the organic coloring material from immediately after production was 9% or greater.

### <7-3> Evaluation of Storage Stability Based on Amount of Foreign Matter Generated

10 mL of each of the stock solutions of ink jet inks of Examples B1 to B33 and Comparative Examples B1 and B2 and 10 mL of each of the ink jet inks of Examples C1 to C33 and Comparative Examples C1 and C2 were placed in predetermined glass bottles and allowed to stand in an environment of 60° C. for 1 week in a state where the gas-liquid interface was present. Thereafter, the stock solutions of ink jet inks and the ink jet inks were respectively filtered through a metal mesh filter having an aperture of 10 μm, the number of solid matter remaining on the metal mesh filter per 1 mm square, and the storage stability was evaluated according to the following evaluation criteria. It can be said that the storage stability is excellent as the amount of foreign matter generated decreases.
A: The number of solid matter per 1 mm square was less than 10.
B: The number of solid matter per 1 mm square was 10 or more and less than 15.
C: The number of solid matter per 1 mm square was 15 or more and less than 30.
D: The number of solid matter per 1 mm square was 30 or more and less than 50.
E: The number of solid matter per 1 mm square was 50 or more.

### <7-4> Evaluation of Degree of Soft Aggregation

A part of each of the stock solutions of ink jet inks of Examples B1 to B33 and Comparative Examples B1 and B2 and a part of each of the ink jet inks of Examples C1 to C33 and Comparative Examples C1 and C2 were taken out and diluted to 100 times with pure water using a particle diameter/particle size distribution measuring device (FPIA-3000S, manufactured by Sysmex Corporation), and the number of particles with a particle diameter of 0.5 μm or greater and 40.0 μm or less was measured in an HPF measurement mode and a standard photographic unit.

Next, the stock solutions of ink jet inks of Examples B1 to B33 and Comparative Examples B1 and B2 and the ink jet inks of Examples C1 to C33 and Comparative Examples C1 and C2 were respectively placed in sample containers, allowed to stand in an environment of 60° C. for 1 week, and diluted to 100 times with pure water using a particle diameter/particle size distribution measuring device (FPIA-3000S, manufactured by Sysmex Corporation) immediately after the standing, and the number of particles with a particle diameter of 0.5 μm or greater and 40.0 μm or less was measured in an HPF measurement mode and a standard photographic unit.

The rate of fluctuation in number of particles with a particle diameter of 0.5 μm or greater and 40.0 μm or less was determined by comparing the above-described measured values with the values when the stock solutions and the ink jet inks were allowed to stand in an environment of 60° C. for 1 week immediately after production, and the degree of soft aggregation was evaluated according to the following evaluation criteria. It can be said that the formation of soft aggregation proceeds and the storage stability is more degraded when the rate of fluctuation increases.
A: The rate of fluctuation from immediately after production was less than 10%.
B: The rate of fluctuation from immediately after production was 10% or greater and less than 15%.
C: The rate of fluctuation from immediately after production was 15% or greater and less than 35%.
D: The rate of fluctuation from immediately after production was 35% or greater and less than 50%.
E: The rate of fluctuation from immediately after production was 50% or greater.

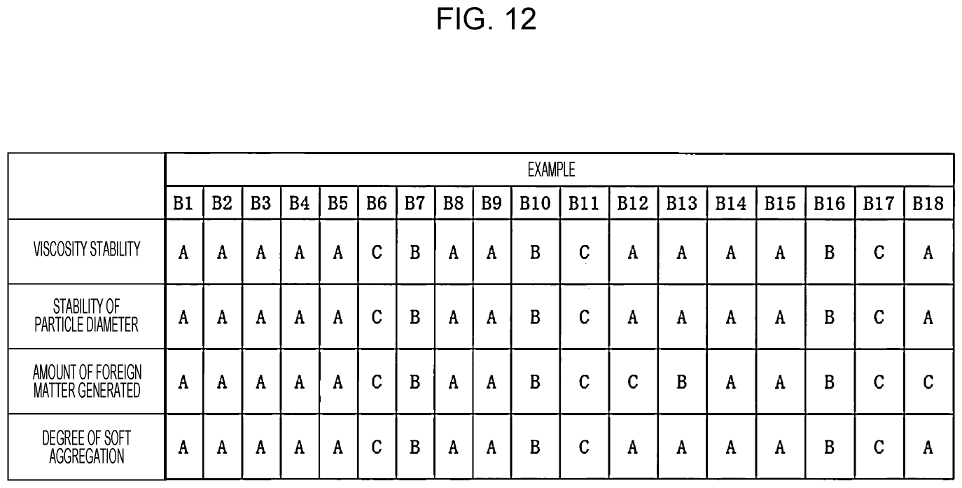

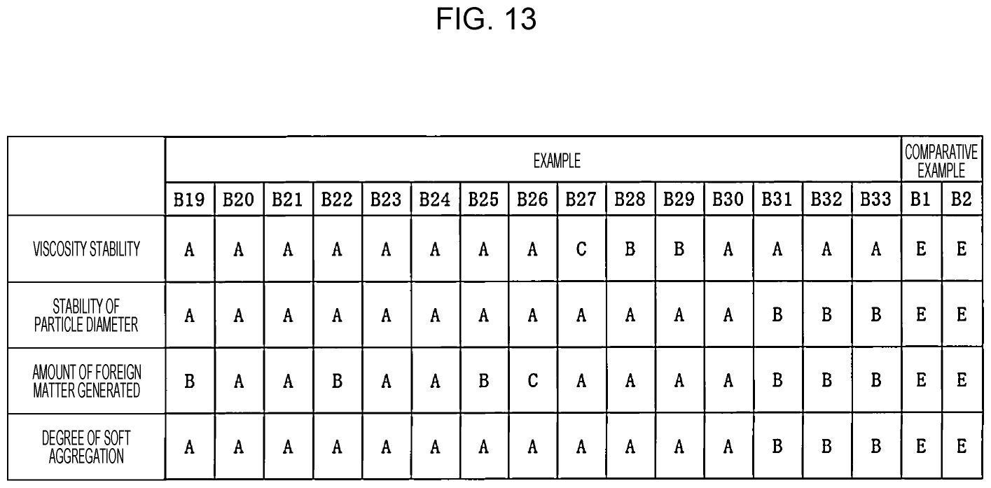

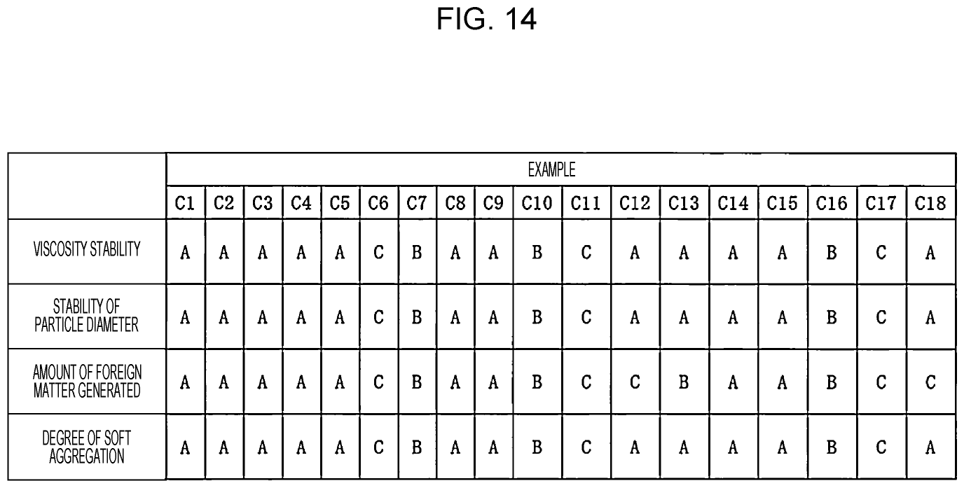

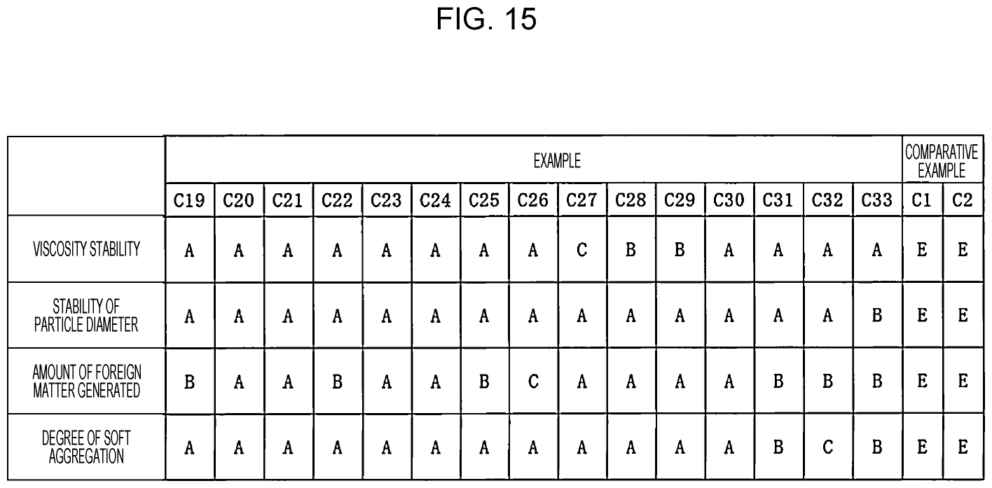

The above-described evaluation results are collectively shown in FIGS. 12 to 15.

As is apparent in FIGS. 12 to 15, excellent results were obtained in the present disclosure. Particularly, in the production of the aqueous coloring material dispersion liquid of the present disclosure, the organic coloring material was suitably disintegrated and dispersed even when the dispersion treatment was performed for a short time of 0.5 hours, and the obtained aqueous coloring material dispersion liquid had excellent dispersion stability of the organic coloring material and excellent storage stability. On the contrary, satisfactory results were not obtained in each comparative example.

What is claimed is:

1. A dispersant-containing liquid comprising:
anionic water-soluble polyester containing a carboxylate and/or a sulfonate;
polyalkylene glycols; and
water.

2. The dispersant-containing liquid according to claim 1,
wherein the dispersant-containing liquid contains a compound represented by Formula (1) as the polyalkylene glycols, 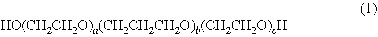
in Formula (1), a, b, and c each independently represent an integer of 1 or greater.

3. The dispersant-containing liquid according to claim 1, 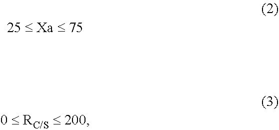
wherein a proportion of a monomer having an aromatic ring structure in all constituent monomers of the water-soluble polyester is defined as Xa [mol %], and a molar ratio of an amount of the carboxylate to an amount of the sulfonate is defined as R_{c/s} [mol %], and
the water-soluble polyester is soluble in water at least in a pH range of 7 or greater and 10 or less.

4. The dispersant-containing liquid according to claim 1,
wherein the polyalkylene glycols have a clouding point of 67° C. or higher.

5. The dispersant-containing liquid according to claim 1, 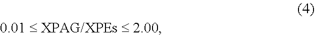
wherein a content of the water-soluble polyester in the dispersant-containing liquid is defined as XPEs [mass %], and a content of the polyalkylene glycols in the dispersant-containing liquid is defined as XPAG [mass %].

6. An aqueous coloring material dispersion liquid comprising:
anionic water-soluble polyester containing a carboxylate and/or a sulfonate;
polyalkylene glycols;
water; and
at least one organic coloring material selected from the group consisting of a pigment, a disperse dye, and an oil-soluble dye.

7. The aqueous coloring material dispersion liquid according to claim 6,
wherein the aqueous coloring material dispersion liquid contains a compound represented by Formula (1) as the polyalkylene glycols, 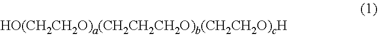
in Formula (1), a, b, and c each independently represent an integer of 1 or greater.

8. The aqueous coloring material dispersion liquid according to claim 6, 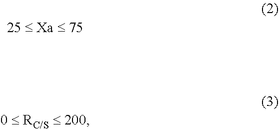
wherein a proportion of a monomer having an aromatic ring structure in all constituent monomers of the water-soluble polyester is defined as Xa [mol %], and a molar ratio of an amount of the carboxylate to an amount of the sulfonate in the water-soluble polyester is defined as R_{c/s} [mol %], and
the water-soluble polyester is soluble in water at least in a pH range of 7 or greater and 10 or less.

9. The aqueous coloring material dispersion liquid according to claim 6,
wherein the polyalkylene glycols have a clouding point of 67° C. or higher.

10. The aqueous coloring material dispersion liquid according to claim 6, 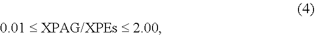
wherein a content of the water-soluble polyester in the aqueous coloring material dispersion liquid is defined as XPEs [mass %], and a content of the polyalkylene glycols in the aqueous coloring material dispersion liquid is defined as XPAG [mass %].

11. The aqueous coloring material dispersion liquid according to claim 6,
wherein the aqueous coloring material dispersion liquid is an ink jet ink.

12. The aqueous coloring material dispersion liquid according to claim 11,
wherein the ink jet ink further contains a moisturizer and a surface tension adjuster.
